(19) United States
(12) Patent Application Publication
(10) Pub. No.: US 2024/0289218 A1
(43) Pub. Date: Aug. 29, 2024

(54) TOUCHUP FOR MEMORY DEVICE USING EMBEDDED ENCODER/DECODER

(71) Applicant: Micron Technology, Inc., Boise, ID (US)

(72) Inventors: David Ebsen, Minnetonka, MN (US); Kishore Kumar Muchherla, San Jose, CA (US); James Fitzpatrick, Laguna Niguel, CA (US); Dung V. Nguyen, San Jose, CA (US); Kevin R. Brandt, Boise, ID (US); Vikas Rana, Pehowa (IN); William Richard Akin, Morgan Hill, CA (US)

(21) Appl. No.: 18/586,048

(22) Filed: Feb. 23, 2024

(30) Foreign Application Priority Data
Feb. 24, 2023 (IN) 202311012692

(51) Int. Cl. G06F 11/10; G06F 13/16

(52) U.S. Cl. CPC G06F 11/1068; G06F 11/1004; G06F 13/1673

(57) ABSTRACT

Data is read from a set of memory cells of a memory device to a buffer of the memory device. One or more bits in error in the data stored by the buffer are corrected by a decoder of the memory device. The decoder corrects the one or more bits in error by decoding the data stored by the buffer. The decoding of the data results in corrected data. An encoder of the memory device encodes the corrected data and the encoded corrected data is programmed to the set of memory cells.

### PRIORITY APPLICATION

This application claims the benefit of priority to Indian Patent Application Serial Number 202311012692, filed Feb. 24, 2023, which is incorporated herein by reference in its entirety.

### TECHNICAL FIELD

Embodiments of the disclosure relate generally to memory sub-systems and more specifically to performing local touch up for low power cells in a memory device using an embedded encoder and decoder.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1 is a diagram illustrating an example computing system that includes a memory sub-system, in accordance with some embodiments of the present disclosure.

FIG. 2 is a diagram illustrating example interactions between components of a memory sub-system in performing low power cell touch up using an embedded encoder and decoder of a memory device, in accordance with some embodiments of the present disclosure.

FIGS. 3 and 4 are flowcharts illustrating an example method in performing low power cell touch up using an embedded encoder and decoder of a memory device, in accordance with some embodiments of the present disclosure.

FIG. 5 is a diagram of an example computer system in which embodiments of the present disclosure may operate.

### DETAILED DESCRIPTION

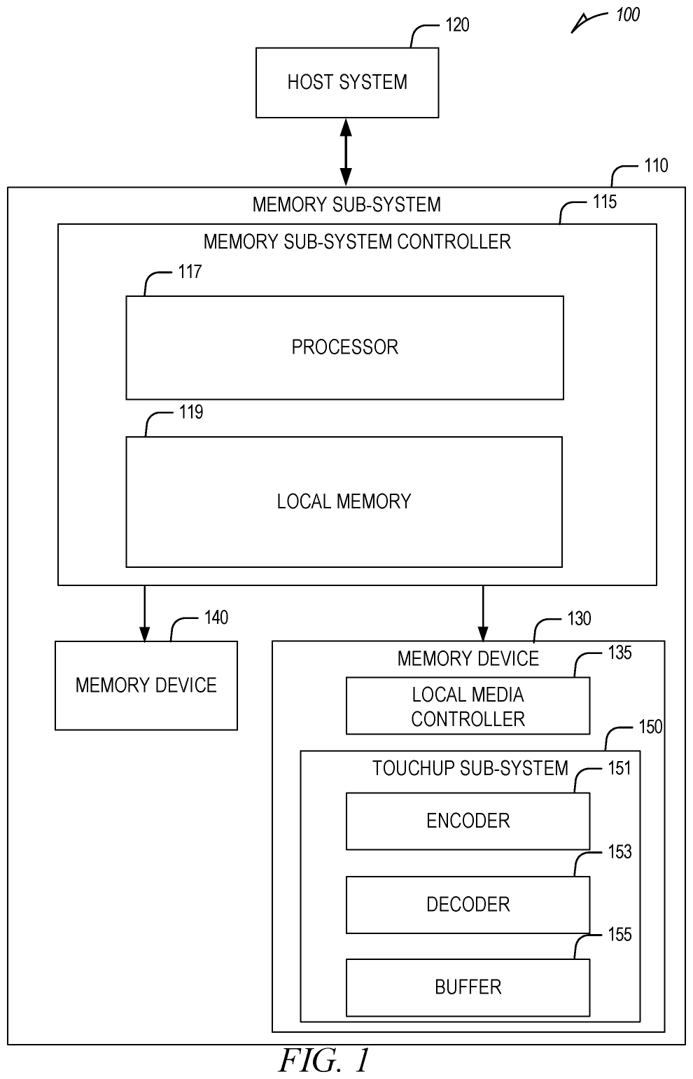

Aspects of the present disclosure are directed to an approach for performing low power cell touchup (also referred to herein simply as “touchup”) in a memory device of a memory sub-system using an embedded encoder and decoder. A memory sub-system can be a storage device (e.g., solid-state drive (SSD)), a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system. A memory sub-system controller typically receives commands or operations from the host system and converts the commands or operations into instructions or appropriate commands to achieve the desired access to the memory components of the memory sub-system.

A memory device can be a non-volatile memory device. One example of a non-volatile memory device is a negative-and (NAND) memory device. A NAND memory device can include multiple NAND dies. Each die may include one or more planes and each plane includes multiple blocks. Each block includes an array that includes pages (rows) and strings (columns). A string includes a plurality of memory cells connected in series. A memory cell (“cell”) is an electronic circuit that stores information. Depending on the cell type, a cell can store one or more bits of binary information and has various logic states that correlate to the number of bits being stored. The logic states can be represented by binary values, such as “0” and “1,” or combinations of such values. Other examples of non-volatile memory devices are described below in conjunction with FIG. 1.

Various memory access operations can be performed on the memory cells. Data can be written to, read from, and erased from memory cells. Memory cells can be grouped into a write unit, such as a page. For some types of memory devices, a page is the smallest write unit. A page size represents a particular number of cells of a page. Data can be written to a block, page-by-page. During write operations, data is programmed into a block of the memory device using a programming sequence that includes multiple passes in which programming pulses are applied to cells in the block. Over the multiple passes, the programming pulses configure the threshold voltages of the cells in each page according to the value that the cells are intended to represent. As the programming sequence progresses, the voltage level of the programming pulses increase until a target voltage level for each cell (also referred to as “write level” herein) is reached.

Charge loss causes cell voltages to degrade over time, which results in data reliability issues for memory devices. Low power cell touchup is often performed to mitigate data reliability issues caused by charge loss. Low power cell touchup (also referred to herein as “cell touchup” or simply as “touchup”) refers to a process for refining cell voltages in a memory device to maintain or reclaim read window bandwidth (RWB). Traditionally, touchup is performed by the memory sub-system controller and includes: reading, over an interface (e.g., based on the Open NAND Flash Interface (ONFI) specification), contents of cells to a decoder sub-system in the memory sub-system controller; decoding, by the controller decoder sub-system, the data to correct bits in error; reencoding the corrected data by an encoder sub-system of the controller; and reprogramming the cells with the encoded corrected data, which again requires data to be communicated over the interface between the controller and the memory device. Hence, traditional techniques for cell touchup are interface bandwidth, controller, and power intensive.

Aspects of the present disclosure address the forgoing issues with traditional cell touchup techniques by utilizing a touchup sub-system embedded in a memory device to perform cell touchup. That is, an encoder, a decoder, and a buffer are embedded in the memory device to enable touchup to be performed by the memory device itself.

In an example, data is read from cells in the memory device to a buffer embedded in the memory device. A decoder embedded in the memory device corrects one or more bits in error in the data by decoding the data, for example, based on a low-density parity-check (LDPC) encoding. An encoder embedded in the memory device reencodes the corrected data (e.g., using LDPC encoding), and the encoded corrected data is programmed back to the cells in the memory device.

Given that the encoder, the decoder, and the buffer are embedded in the memory device, touchups can be performed within the memory device itself without reading data over the interface with the memory sub-system controller. Performing touchup in this manner reduces consumption of controller resources and increases bandwidth in the interface between the controller and the memory device (e.g., an ONFI). In addition, this manner of touchup also reduces power consumption by the memory sub-system by eliminating the power consumption due to data transfer over the interface and the power consumption by the encoder and decoder sub-systems of the controller.

FIG. 1 illustrates an example computing system 100 that includes a memory sub-system 110, in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a SSD, a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 120 can include a processor chipset and a software stack executed by the processor chipset. The processor chipset can include one or more cores, one or more caches, a memory controller (e.g., NVDIMM controller), and a storage protocol controller (e.g., peripheral component interconnect express (PCIe) controller, serial advanced technology attachment (SATA) controller). The host system 120 uses the memory sub-system 110, for example, to write data to the memory sub-system 110 and read data from the memory sub-system 110.

The host system 120 can be coupled to the memory sub-system 110 via a host interface. Examples of a host interface include, but are not limited to, a SATA interface, a PCIe interface, USB interface, Fibre Channel, Serial Attached SCSI (SAS), Small Computer System Interface (SCSI), a double data rate (DDR) memory bus, a DIMM interface (e.g., DIMM socket interface that supports DDR), ONFI, Low Power Double Data Rate (LPDDR), or any other interface. The host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the PCIe interface. The host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include NAND type flash memory and write-in-place memory, such as a three-dimensional cross-point (3D cross-point) memory device, which is a cross-point array of non-volatile memory cells. A cross-point array of non-volatile memory can perform bit storage based on a change of bulk resistance in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and 3D NAND.

Each of the memory devices 130 can include one or more arrays of memory cells. One type of memory cell, for example, single level cells (SLC), can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks. For example, the memory device can include a set of blocks. Design specifications may define a constraint on a minimum number of valid blocks for the memory device 130 that may be different from the number of blocks in the set of blocks on the device.

Although non-volatile memory components such as NAND type flash memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), NOR flash memory, and electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, and the like. The local memory 119 can also include ROM for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130 and/or the memory device 140. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system 120 into command instructions to access the memory devices 130 and/or the memory device 140 and convert responses associated with the memory devices 130 and/or the memory device 140 into information for the host system 120.

In some embodiments, the memory devices 130 include local media controllers 135 that operate in conjunction with memory sub-system controller 115 to execute operations on one or more memory cells of the memory devices 130.

The memory device 130 also includes an encoder 151, a decoder 153, and a buffer 155. Together, the encoder 151, the decoder 153, and the buffer 155 support local low power cell touchup functionality. Hence, in some embodiments, the encoder 151, the decoder 153, and the buffer 155 for part of a touchup sub-system 150 within the memory device 130. In an example of a touchup process performed by the memory device 130, data is read from cells in the memory device 130 to the buffer 155, the decoder 153 corrects one or more bits in error in the data by decoding the data, for example, based on a LDPC encoding, the encoder 151 reencodes the corrected data, and the encoded corrected data is programmed back to the cells in the memory device 130. Given that the encoder 151, the decoder 153, and the buffer 155 used in performing the touchup are embedded in the memory device 130, touchups can be performed within the memory device 130 without further processing by and communication with the memory sub-system controller 115. Hence, having the touchup sub-system 150 embedded in the memory device 130 reduces consumption of controller resources and increases bandwidth in the interface between the controller 115 and the memory device 130 (e.g., an ONFI).

In some embodiments, the local media controller 135 includes at least a portion of the touchup sub-system 150. For example, the local media controller 135 may work in conjunction with the encoder 151, the decoder 153, and the buffer 155 to perform one or more operations to support touchups within the memory device 130. In addition, the memory sub-system controller 115 can include a processor 117 (processing device) configured to execute instructions stored in local memory 119 for performing one or more operations to support low power cell touchup by the memory device 130.

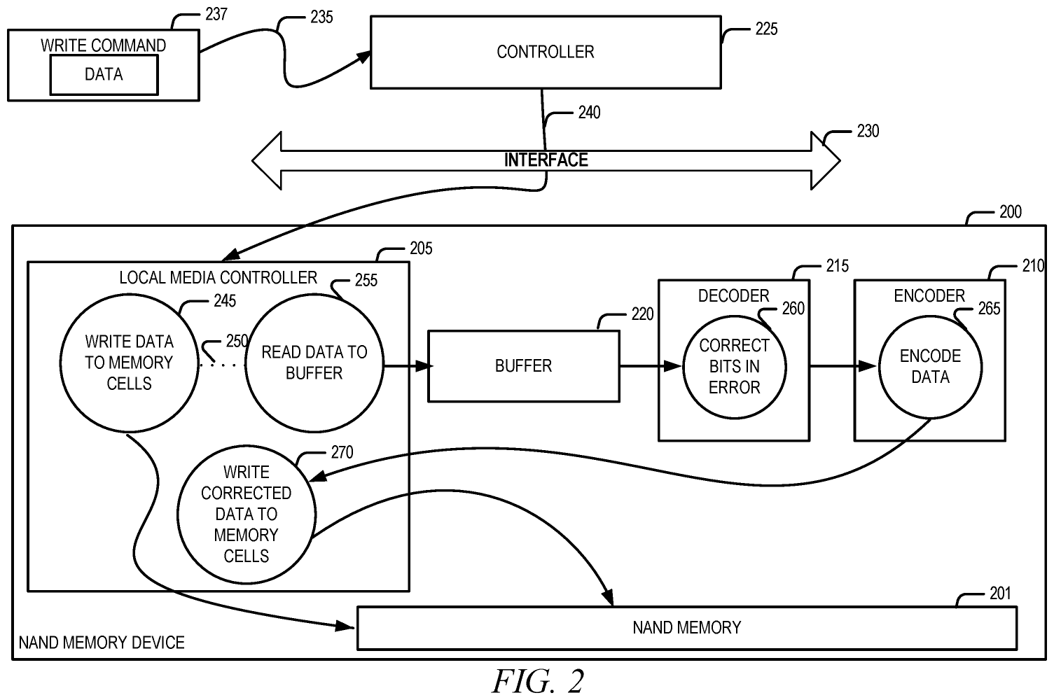

FIG. 2 is a diagram illustrating example interactions between components of a memory sub-system in performing low power cell touch up using an embedded encoder and decoder of a memory device, in accordance with some embodiments of the present disclosure. In the example illustrated in FIG. 2, the memory device 130 of FIG. 1 is in the example form of a NAND memory device 200 that includes: NAND memory 201, local media controller 205, which is an example of local media controller 135; an encoder 210, which is an example of the encoder 151; a decoder 215, which is an example of the decoder 153; and a buffer 220, which is an example of the buffer 155. The NAND memory device 200 is also communicatively coupled to a controller 225, which is an example of the controller 115, via an interface 230 (e.g., a bus) based on the ONFI specification.

The NAND memory 201 includes multiple NAND dies; each die may include one or more planes, each of which includes multiple blocks. Each block includes a 2D or 3D array that includes pages (rows) and strings (columns). A string includes a plurality of memory cells connected in series. Each memory cell is used to represent one or more bit values. Each cell includes a transistor, and within each cell, data is stored as the threshold voltage of the transistor.

A single NAND flash cell includes a transistor that stores an electric charge on a memory layer that is isolated by oxide insulating layers above and below. Within each cell, data is stored as the threshold voltage of the transistor. SLC NAND, for example, can store one bit per cell. Other types of memory cells, such as MLCs, TLCs, QLCs, and PLCs, can store multiple bits per cell. In this example, the NAND memory 201 includes an SLC portion that includes multiple SLCs and a QLC portion that includes multiple QLCs.

Within the NAND memory 201, strings are connected within a NAND block to allow storage and retrieval of data from selected cells. NAND cells in the same column are connected in series to form a bit line (BL). All cells in a bit line are connected to a common ground on one end and a commonsense amplifier on the other for reading the threshold voltage of one of the cells when decoding data. NAND cells are connected horizontally at their control gates to a word line (WL) to form a page. In MLC, TLC, QLC, and PLC NAND, a page is a set of connected cells that share the same word line and is the minimum unit to program.

As noted above, each NAND cell stores data in the form of the threshold voltage (V_{T}) of the transistor. The range of threshold voltages of a memory cell can be divided into a number of regions based on the number of bits stored by the cell where each region corresponds to a value that can be represented by the cell. More specifically, each region corresponds to a charge level (also referred to herein as “read level”) and each charge level decodes into a multi-bit value. For example, a TLC NAND flash cell can be at one of eight charge levels: L0, L1, L2, L3, L4, L5, L6, or L7. Each charge level decodes into a 3-bit value that is stored in the flash cell (e.g., 111, 110, 100, 000, 010, 011, 001, and 101).

During write operations, data is programmed into a block of the NAND memory 201 using a programming sequence that includes multiple passes in which programming pulses are applied to cells in the block. Over the multiple passes, the programming pulses configure the threshold voltages of the cells in each page according to the value the cells are intended to represent. As the programming sequence progresses, the voltage level of the programming pulses increase until a target voltage level for each cell (also referred to as “write level” herein) is reached. The multiple passes may include a coarse programming pass and a fine programming pass. During the coarse programming pass, threshold voltages of cells are configured to approximate the target voltage level for each cell, while in the fine programming pass, threshold voltages of cells are configured more precisely according to the target voltage level for each cell.

As shown, at operation 235, a write command 237 to program data to the memory device 130 is received by controller 225 from a host system (e.g., the host system 120). In turn, the controller 225 provides the data to the memory device 200 via the interface 230, at operation 240. That is, contrary to conventional handling of write commands, the controller 225 simply serves as a pass through for the program data.

At operation 245, the memory device 200 writes the data to NAND cells in the NAND memory 201 in multiple passes using coarse and fine programming, as described above. In this example, the data is programmed to a page in the QLC portion of the NAND memory 201. To perform the coarse programming, the local media controller 205 reads the encoded data from the set of SLCs to the buffer 220, the decoder 215 decodes the encoded data, and the encoder 210 reencodes the data, which is programmed to the QLCs using coarse programming. Similarly, to perform the fine programming, the local media controller 205 reads the data (the reencoded data) from the QLCs to the buffer 220, the decoder 215 decodes the data, and the encoder 210 reencodes the data, which is programmed to the QLCs using fine programming. In this example, the encoder 210 comprises an LDPC encoder and thus utilizes LDPC encoding to encode the data.

For some embodiments, prior to the operation 245, the encoder 210 may encode the data before the local media controller 205 writes the encoded data to a page in the SLC portion of the NAND memory 201. That is, the encoded data may initially be programmed to a first page in the SLC portion of the NAND memory 201, and the encoded data may be read from the first page to the buffer 220 where it is decoded by the decoder 215, reencoded by the encoder 210, and programmed to a second page in the QLC portion of the NAND memory 201 at operation 245.

After a predefined interval 250, the memory device 200 performs a touchup on the QLCs to which the data was programmed during operation 245. In performing the touchup, the local media controller 205 reads data from the QLCs to the buffer 220 (operation 255) and the decoder 215 corrects one or more bits in error in the data in the buffer 220 (operation 260). The decoder 215 corrects the one or more bits in error by decoding the data. As noted above, the data may be encoded using an LDPC encoding, and thus, the decoder 215 may comprise an LDPC decoder. The decoding of the data results in corrected data. At operation 265, the encoder 210 encodes the corrected data (e.g., using LDPC encoding), which results in encoded corrected data. The local media controller 205 programs (writes) the encoded corrected data to the QLCs, at operation 270.

It shall be noted that given that because the encoder 210, the decoder 215, and the buffer 220, which are responsible for performing the touchup, are embedded in the memory device 200, the memory device 200 is able to perform touchups without exchanging data or otherwise communicating with the controller 225 via the interface 230, which is contrary to conventional touchup techniques in which data would be read from the memory device 200 over the interface 230 to the controller 225 and the touched up data is sent back to the memory device 200 by the controller 225 over the interface 230. Further, it shall be appreciated that although a single touchup is addressed above, the memory device 200 may perform any number of touchups on a given set of cells. In some examples, touchups are performed on a routine interval, while in other examples, touchups may be performed at different intervals over the lifetime of the memory device 200.

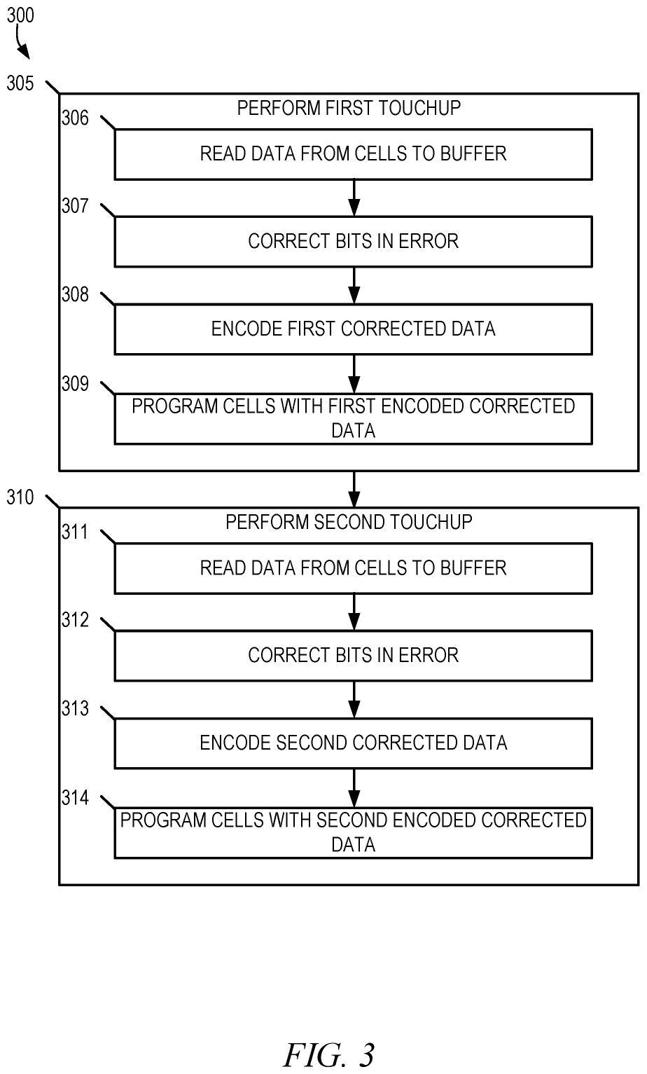

FIG. 3 is a flowcharts illustrating an example method in performing low power cell touch up using an embedded encoder/decoder of a memory device, in accordance with some embodiments of the present disclosure.

The method 300 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some embodiments, the method 300 is performed at least in part by touchup sub-system 150 of FIG. 1. Although processes are shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 305, a memory device (e.g., the memory device 130) performs a first touchup on a set of cells. The first set of cells may, for example, correspond to a page in the memory device. As shown, the operation 305 can include operations 306, 307, 308, and 309. At operation 306, a processing device of the memory device (e.g., the local media controller 135) reads data from the set of cells (e.g., one or more QLCs) to a buffer (e.g., buffer 155) of the memory device. The data read from the set of memory cells to the buffer is encoded, for example, using LDPC encoding.

A decoder (e.g., decoder 153) of the memory device corrects one or more bits in error in the data in the buffer, at operation 307. The decoder corrects the one or more bits in error by decoding the data. As noted above, the data may be encoded using an LDPC encoding, and thus, the decoder may comprise an LDPC decoder. The decoding of the data results in first corrected data.

An encoder (e.g., the encoder 151) of the memory device encodes the corrected data, at operation 308. For example, the encoder may utilize LDPC encoding to encode the corrected data. The encoding of the corrected data results in first encoded corrected data. The processing device, at operation 309, programs (writes) the set of memory cells with the first encoded corrected data.

At operation 310, the memory device performs a second touchup on the set of cells. The memory device performs the second touchup at a predefined interval. That is, the first touchup and the second touchup are temporally separated by a time gap defined by a predetermined interval for performing cell touchup. As shown, the operation 310 includes operations 311, 312, 313, and 314.

At operation 311, the processing device reads data from the set of cells to the buffer of the memory device. That is, the processing device reads the first encoded corrected data to the memory device.

The decoder of the memory device corrects one or more bits in error in the data (the first encoded corrected data) in the buffer, at operation 312, by decoding the data. The decoding of the data results in second corrected data.

The encoder of the memory device encodes the second corrected data, at operation 313 (e.g., using LDPC encoding), to encode the second corrected data. The encoding of the second corrected data results in second encoded corrected data. The processing device, at operation 314, programs the set of memory cells of the memory device with the second encoded corrected data.

It shall be noted that given that the first and second touchups rely upon a buffer, encoder, and decoder that are embedded in the memory device, the memory device is able to perform the first and second touchup without exchanging information or otherwise communicating with the controller via the bus.

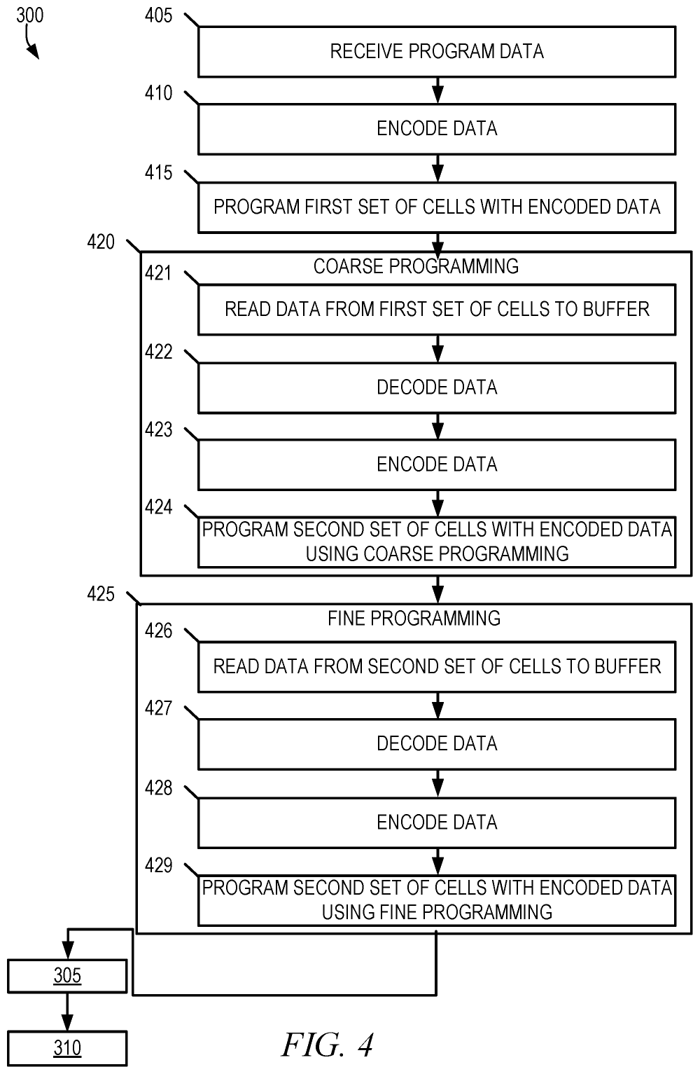

As shown in FIG. 4, the method 300 may, in some embodiments, further include 405, 410, 415, 420, and 425. Consistent with these embodiments, the operations 405, 410, 415, 420, and 425 are performed prior to operation 305 where the memory device performs the first touchup.

At operation 405, the processing device of the memory device receives data to be written (programmed) to the memory device. The data may be received from a controller (e.g., memory sub-system controller 115) via a bus (e.g., based on the ONFI specification) and may be included in a write command received by the controller from a host system (e.g., the host system 120).

The encoder of the memory device encodes the data, at operation 410. As previously noted, the encoder may comprise an LDPC encoder and thus may utilize LDPC encoding to encode the data. The processing device, at operation 415, writes the encoded data to a first set of cells in the memory device. For example, the processing device may write the encoded data to a first page comprising SLCs.

At operation 420, the memory device performs coarse programming to write data to write the encoded data to a second set of cells (e.g., a second page comprising QLCs). As shown, the operation 420 may include operations 421, 422, 423, and 424. At operation 421, the processing device reads the encoded data from the first set of cells to the buffer. The decoder decodes the encoded data, at operation 422, and the encoder reencodes the data, at operation 423. At operation 424, the processing device programs the second set of cells with the reencoded data using coarse programming.

At operation 425, the memory device performs fine programming to complete the writing of the data to the second set of cells. As shown, the operation 420 may include operations 426, 427, 428, and 429. At operation 426, the processing device reads the data (the reencoded data) from the second set of cells to the buffer. The decoder decodes the data, at operation 427, and the encoder reencodes the data, at operation 428. At operation 429, the processing device programs the second set of cells with the reencoded data using fine programming. As noted above, the second set of cells may be a set of QLCs. Further, the second set of cells discussed in reference to FIG. 4 correspond to the set of cells from which the data is read at operation 305 discussed above in reference to FIG. 3.

In view of the disclosure above, various examples are set forth below. It should be noted that one or more features of an example, taken in isolation or combination, should be considered within the disclosure of this application.

Example 1. A memory device comprising: a set of memory cells; a buffer operatively coupled to the set of memory cells, the buffer to store data read from the set of memory cells; a decoder operatively coupled to the buffer, the decoder configured to correct one or more bits in error in the data stored by the buffer by decoding the data, the decoding of the data resulting in corrected data, the corrected data being stored by the buffer; and an encoder to encode the corrected data, the encoding of the corrected data resulting in encoded corrected data, the encoded corrected data being stored by the buffer prior to being programmed to the set of memory cells.

Example 2. The memory device of Example 1, further comprising a processing device coupled to the set of memory cells, the buffer, the decoder, and the encoder, the processing device configured to perform operations comprising: programming the set of memory cells with the data; reading the data from the set of memory cells to the buffer; and programming the set of memory cells with the encoded corrected data.

Example 3. The memory device of any one or more of Examples 1 and 2, wherein the processing device reads the data from the set of memory cells and programs the encoded corrected data to the set of memory cells without communicating with a memory controller.

Example 4. The memory device of any one or more of Examples 1-3, wherein: the processing device is further configured to perform operations comprising receiving, from a memory sub-system controller, the data for programming to the set of memory cells, the data being included in a command received by the memory sub-system controller; and the encoder is further to encode the data prior to the data being programmed to the set of memory cells.

Example 5. The memory device of any one or more of Examples 1-4, wherein: the data is encoded using low-density parity check (LDPC) code; the decoder comprises an LDPC decoder; and the encoder comprises an LDPC encoder.

Example 6. The memory device of any one or more of Examples 1-5, wherein: the decoder is further to decode the encoded corrected data to correct one or more bits in error in the encoded corrected data, the decoding of the encoded corrected data resulting in further corrected data; and the encoder is further to encode the further corrected data prior to the further corrected data being programmed to the set of memory cells.

Example 7. The memory device of any one or more of Examples 1-6, wherein the decoder decodes the encoded corrected data after a predetermined interval.

Example 8. A method comprising: reading data from a set of memory cells of a memory device to a buffer of the memory device; correcting one or more bits in error in the data stored by the buffer, the correcting of the one or more bits in error comprising decoding, by a decoder of the memory device, the data stored by the buffer, the decoding of the data resulting in corrected data; encoding, by an encoder of the memory device, the corrected data, the encoding of the corrected data resulting in encoded corrected data; and programming the encoded corrected data to the set of memory cells.

Example 9. The method of Example 8, wherein the encoded corrected data is stored by the buffer prior to programming the encoded corrected data to the set of memory cells.

Example 10. The method of any one or more of Examples 8 or 9, further comprising: receiving, by the memory device, the data for programming to the set of memory cells, the data being included in a command received by a memory sub-system controller and being provided to the memory device by the memory sub-system controller; and programming the data to the set of memory cells.

Example 11. The method of any one or more of Examples 8-10, wherein the set of memory cells is a first set of memory cells, the method further comprising: encoding, by the encoder, the data prior to programming the data to the set of memory cells.

Example 12. The method of any one or more of Examples 8-11, wherein: the data is encoded using low-density parity check (LDPC) code; the decoder comprises an LDPC decoder; and the encoder comprises an LDPC encoder.

Example 13. The method of any one or more of Examples 8-12, further comprising: reading the encoded corrected data from the set of memory cells to the buffer of the memory device; correcting one or more additional bits in error in the encoded corrected data stored by the buffer by decoding, by the decoder of the memory device, the encoded corrected data stored by the buffer, the decoding of the data resulting in further corrected data; encoding, by the encoder of the memory device, the further corrected data, the encoding of the corrected data resulting in encoded further corrected data; and programming the encoded further corrected data to the set of memory cells.

Example 14. The method of any one or more of Examples 8-13, wherein the reading of the encoded corrected data from the set of memory cells is performed after a predetermined interval from programming the encoded corrected data to the set of memory cells.

Example 15. The method of any one or more of Examples 8-14, wherein the reading of the data from the set of memory cells to the buffer is performed without communicating information over an interface with a memory controller.

Example 16. A memory sub-system comprising: a memory device comprising: a first set of memory cells, a second set of memory cells, an encoder, a decoder, and a buffer; and a processing device operatively coupled with the memory device, configured to perform operations comprising: receiving a command to program data to the memory device; and providing the data to the memory device; the memory device configured to perform operations comprising: encoding, by the encoder, the data received from the processing device in a first encoding operation, the first encoding operation resulting in first encoded data; programming the first set of memory cells with the first encoded data; reading the first encoded data from the first set of memory cells to the buffer; decoding, by the decoder, the first encoded data, the decoded data being stored by the buffer; encoding, by the encoder, the decoded data being stored by the buffer in a second encoding operation, the second encoding operation resulting in second encoded data; and programming the second set of memory cells with the second encoded data.

Example 17. The memory sub-system of any one or more of Examples 16, wherein the memory device is configured to perform further operations comprising: reading the second encoded data from the second set of memory cells to the buffer; correcting one or more bits in error in the second encoded data by decoding, by the decoder, the second encoded data, the decoding of the second encoded data resulting in corrected data; encoding, by the encoder, the corrected data, the encoding of the corrected data resulting in encoded corrected data; and programming the second set of memory cells with the encoded corrected data.

Example 18. The memory sub-system of any one or more of Examples 16 or 17, wherein the memory device is configured to perform further operations comprising: reading the encoded corrected data from the second set of memory cells to the buffer of the memory device; correcting one or more additional bits in error in the encoded corrected data stored by the buffer by decoding, by the decoder, the encoded corrected data stored by the buffer, the decoding of the data resulting in further corrected data; encoding, by the encoder, the further corrected data, the encoding of the corrected data resulting in encoded further corrected data; and programming the second set of memory cells with the encoded further corrected data.

Example 19. The memory sub-system of any one or more of Examples 16-18, wherein: the data is encoded using low-density parity check (LDPC) code; the decoder comprises an LDPC decoder; and the encoder comprises an LDPC encoder.

Example 20. The memory sub-system of any one or more of Examples 16-19, wherein: the memory device comprises a flash memory device; the first set of memory cells comprises single level cell (SLC) memory; and the second set of memory cells comprises quad-level cell (QLC) memory.

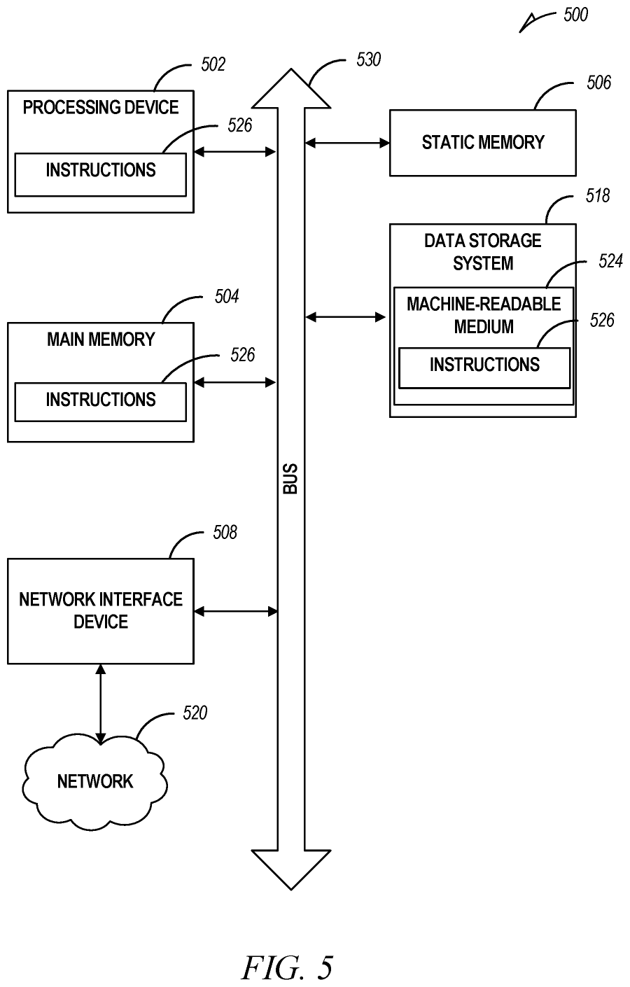

FIG. 5 illustrates an example machine in the form of a computer system 500 within which a set of instructions can be executed for causing the machine to perform any one or more of the methodologies discussed herein. In some embodiments, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute operations to support touchup by the touchup sub-system 150 of the memory device 130 of FIG. 1 such as operations performed by the local media controller 135). In alternative embodiments, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., ROM, flash memory, DRAM such as SDRAM or RDRAM, etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an ASIC, a FPGA, a digital signal processor (DSP), a network processor, or the like. The processing device 502 is configured to execute instructions 526 for performing the operations and steps discussed herein. The computer system 500 can further include a network interface device 508 to communicate over a network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In one embodiment, the instructions 526 include instructions to implement or support touchup functionality by a memory device (e.g., operations performed by the local media controller 135 of FIG. 1). While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, ROMs, RAMs, EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a ROM, RAM, magnetic disk storage media, optical storage media, flash memory components, and so forth.

In the foregoing specification, embodiments of the disclosure have been described with reference to specific example embodiments thereof. It will be evident that various modifications can be made thereto without departing from the broader scope of embodiments of the disclosure as set forth in the following claims. The specification and drawings are, accordingly, to be regarded in an illustrative sense rather than a restrictive sense.

What is claimed is:

1. A memory device comprising:
a set of memory cells;
a buffer operatively coupled to the set of memory cells, the buffer to store data read from the set of memory cells;
a decoder operatively coupled to the buffer, the decoder configured to correct one or more bits in error in the data stored by the buffer by decoding the data, the decoding of the data resulting in corrected data, the corrected data being stored by the buffer; and
an encoder to encode the corrected data, the encoding of the corrected data resulting in encoded corrected data, the encoded corrected data being stored by the buffer prior to being programmed to the set of memory cells.

2. The memory device of claim 1, further comprising a processing device coupled to the set of memory cells, the buffer, the decoder, and the encoder, the processing device configured to perform operations comprising:
programming the set of memory cells with the data;
reading the data from the set of memory cells to the buffer; and
programming the set of memory cells with the encoded corrected data.

3. The memory device of claim 2, wherein the processing device reads the data from the set of memory cells and programs the encoded corrected data to the set of memory cells without communicating with a memory controller.

4. The memory device of claim 2, wherein:
the processing device is further configured to perform operations comprising receiving, from a memory sub-system controller, the data for programming to the set of memory cells, the data being included in a command received by the memory sub-system controller; and
the encoder is further to encode the data prior to the data being programmed to the set of memory cells.

5. The memory device of claim 1, wherein:
the data is encoded using low-density parity check (LDPC) code;
the decoder comprises an LDPC decoder; and
the encoder comprises an LDPC encoder.

6. The memory device of claim 1, wherein:
the decoder is further to decode the encoded corrected data to correct one or more bits in error in the encoded corrected data, the decoding of the encoded corrected data resulting in further corrected data; and
the encoder is further to encode the further corrected data prior to the further corrected data being programmed to the set of memory cells.

7. The memory device of claim 6, wherein the decoder decodes the encoded corrected data after a predetermined interval.

8. A method comprising:
reading data from a set of memory cells of a memory device to a buffer of the memory device;
correcting one or more bits in error in the data stored by the buffer, the correcting of the one or more bits in error comprising decoding, by a decoder of the memory device, the data stored by the buffer, the decoding of the data resulting in corrected data;
encoding, by an encoder of the memory device, the corrected data, the encoding of the corrected data resulting in encoded corrected data; and
programming the encoded corrected data to the set of memory cells.

9. The method of claim 8, wherein the encoded corrected data is stored by the buffer prior to programming the encoded corrected data to the set of memory cells.

10. The method of claim 8, further comprising:
receiving, by the memory device, the data for programming to the set of memory cells, the data being included in a command received by a memory sub-system controller and being provided to the memory device by the memory sub-system controller; and
programming the data to the set of memory cells.

11. The method of claim 10, wherein the set of memory cells is a first set of memory cells, the method further comprising:
encoding, by the encoder, the data prior to programming the data to the set of memory cells.

12. The method of claim 8, wherein:
the data is encoded using low-density parity check (LDPC) code;
the decoder comprises an LDPC decoder; and
the encoder comprises an LDPC encoder.

13. The method of claim 8, further comprising:
reading the encoded corrected data from the set of memory cells to the buffer of the memory device;
correcting one or more additional bits in error in the encoded corrected data stored by the buffer by decoding, by the decoder of the memory device, the encoded corrected data stored by the buffer, the decoding of the data resulting in further corrected data;
encoding, by the encoder of the memory device, the further corrected data, the encoding of the corrected data resulting in encoded further corrected data; and
programming the encoded further corrected data to the set of memory cells.

14. The method of claim 13, wherein the reading of the encoded corrected data from the set of memory cells is performed after a predetermined interval from programming the encoded corrected data to the set of memory cells.

15. The method of claim 8, wherein the reading of the data from the set of memory cells to the buffer is performed without communicating information over an interface with a memory controller.

16. A memory sub-system comprising:
a memory device comprising: a first set of memory cells, a second set of memory cells, an encoder, a decoder, and a buffer; and
a processing device operatively coupled with the memory device, configured to perform operations comprising:
receiving a command to program data to the memory device; and
providing the data to the memory device;
the memory device configured to perform operations comprising:
encoding, by the encoder, the data received from the processing device in a first encoding operation, the first encoding operation resulting in first encoded data;
programming the first set of memory cells with the first encoded data;
reading the first encoded data from the first set of memory cells to the buffer;
decoding, by the decoder, the first encoded data, the decoded data being stored by the buffer;
encoding, by the encoder, the decoded data being stored by the buffer in a second encoding operation, the second encoding operation resulting in second encoded data; and
programming the second set of memory cells with the second encoded data.

17. The memory sub-system of claim 16, wherein the memory device is configured to perform further operations comprising:
reading the second encoded data from the second set of memory cells to the buffer;
correcting one or more bits in error in the second encoded data by decoding, by the decoder, the second encoded data, the decoding of the second encoded data resulting in corrected data;
encoding, by the encoder, the corrected data, the encoding of the corrected data resulting in encoded corrected data; and
programming the second set of memory cells with the encoded corrected data.

18. The memory sub-system of claim 17, wherein the memory device is configured to perform further operations comprising:
reading the encoded corrected data from the second set of memory cells to the buffer of the memory device;
correcting one or more additional bits in error in the encoded corrected data stored by the buffer by decoding, by the decoder, the encoded corrected data stored by the buffer, the decoding of the data resulting in further corrected data;
encoding, by the encoder, the further corrected data, the encoding of the corrected data resulting in encoded further corrected data; and
programming the second set of memory cells with the the encoded further corrected data.

19. The memory sub-system of claim 16, wherein:
the data is encoded using low-density parity check (LDPC) code;
the decoder comprises an LDPC decoder; and
the encoder comprises an LDPC encoder.

20. The memory sub-system of claim 16, wherein:
the memory device comprises a flash memory device;
the first set of memory cells comprises single level cell (SLC) memory; and
the second set of memory cells comprises quad-level cell (QLC) memory.
